(19) United States
(12) Patent Application Publication
(10) Pub. No.: US 2008/0149252 A1
(43) Pub. Date: Jun. 26, 2008

(54) MOSAIC AND METHOD FOR PRODUCING IT

(76) Inventor: Brian H. Welker, Sugar Land, TX (US)

Correspondence Address: HUSCH BLACKWELL SANDERS LLP, 4801 Main Street, Suite 1000, KANSAS CITY, MO, 64112, US

(21) Appl. No.: 11/613,885

(22) Filed: Dec. 20, 2006

(51) Int. Cl. B44C 3/12

(52) U.S. Cl. 156/63; 156/265

(57) ABSTRACT

A mosaic formed from bony processes and a method for producing it. The method for producing the mosaic includes the steps of providing a generally planar substratum, providing a bony process, cutting the bony process into cross-sectional pieces, arranging the cross-sectional pieces on the substratum, and affixing the cross-sectional pieces to the substratum.

### CROSS-REFERENCE TO RELATED APPLICATIONS

None.

### BACKGROUND OF THE INVENTION

The art of mosaic making has existed for centuries. It involves the creation of surface decorations made by inlaying pieces of variously colored material to form pictures or patterns.

The pieces of material used to form mosaics are usually ceramic, marble, or stone. The pieces of material are normally held in place by mortar, glue, or grouting.

In rural areas and areas where hunting takes place, it is desirable to have decor that incorporates the sport of hunting into its design. Accordingly, a need exists for a way to produce such decor.

### SUMMARY OF THE INVENTION

The present invention is directed to a method for producing a mosaic that includes the steps of providing a generally planar substratum, providing a bony process, cutting the bony process into cross-sectional pieces, arranging the cross-sectional pieces on the substratum, and affixing the cross-sectional pieces to the substratum.

The present invention is also directed to a mosaic that includes a generally planar substratum and at least one bony process that is cut into a plurality of cross-sectional pieces. The bony process cross-sectional pieces are polished using an abrasive material. The cross-sectional pieces are arranged on and affixed to the substratum. The voids created by the arranging of the cross-sectional pieces are filled with a material.

### DESCRIPTION OF THE SEVERAL VIEWS OF THE DRAWINGS

FIG. 1 is a plan view of the mosaic in accordance with one embodiment of the present invention;

FIG. 2 is a right perspective view of the mosaic containing four legs in accordance with one embodiment of the present invention;

FIG. 3 is an exploded view of a deer antler in accordance with one embodiment of the present invention;

FIG. 4A is a plan view of a bony process cross-sectional piece in accordance with one embodiment of the present invention;

FIG. 4B is a plan view of a bony process cross-sectional piece in accordance with one embodiment of the present invention; and

FIG. 4C is a plan view of a bony process cross-sectional piece in accordance with one embodiment of the present invention.

### DETAILED DESCRIPTION OF THE INVENTION

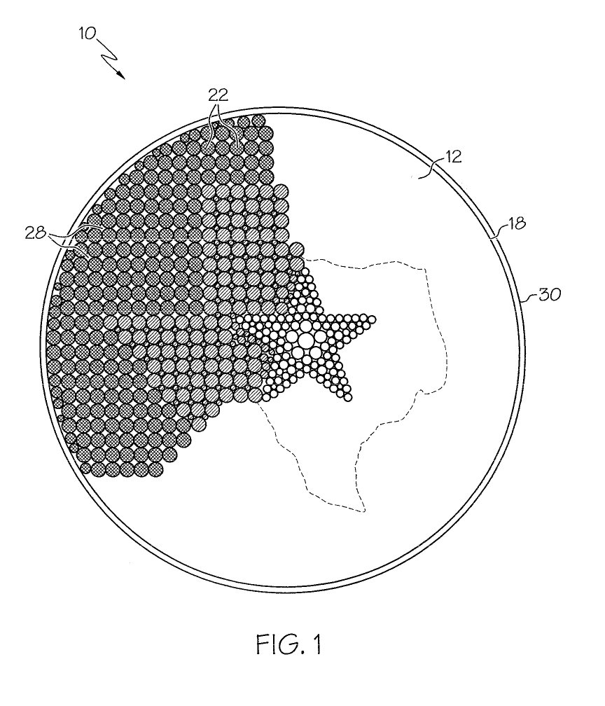

The present invention is directed to a mosaic 10 constructed from bony process cross-sectional pieces 22 and a method for producing the mosaic 10. As shown in FIG. 1, the mosaic 10 includes a substratum 12 and bony process cross-sectional pieces 22. The substratum 12 has a first side 14, a second side 16, and at least one sidewall 18. The bony process cross-sectional pieces 22 have first sides 24 and second sides 26.

In order to produce a mosaic 10 constructed from bony process cross-sectional pieces 22, a generally circular substratum 12 with a generally planar first side 14 is first provided. It will be appreciated by one skilled in the art that the substratum 12 may also be one of many numerous shapes, including, but not limited to, polygonal, trapezoidal, rectangular, square, triangular, and oval. In one embodiment, the substratum 12 has a coefficient of thermal expansion similar to the coefficient of thermal expansion of the bony process or processes 20 used to construct the mosaic 10.

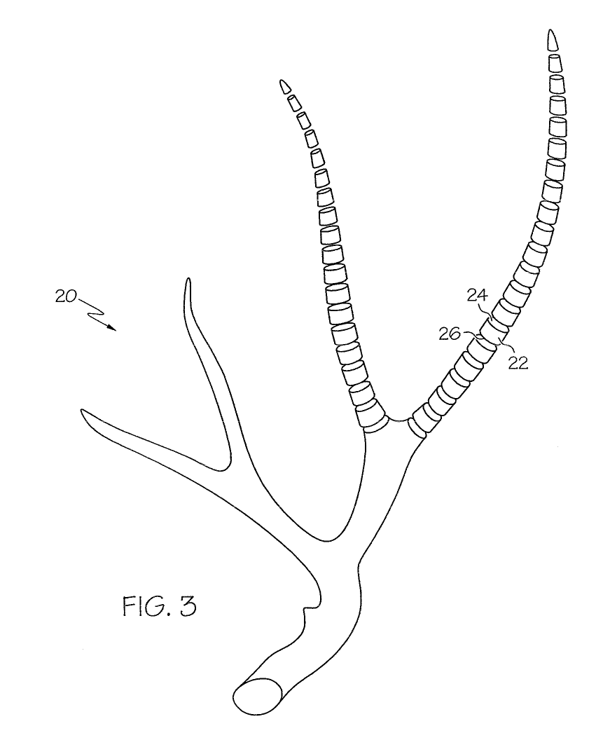

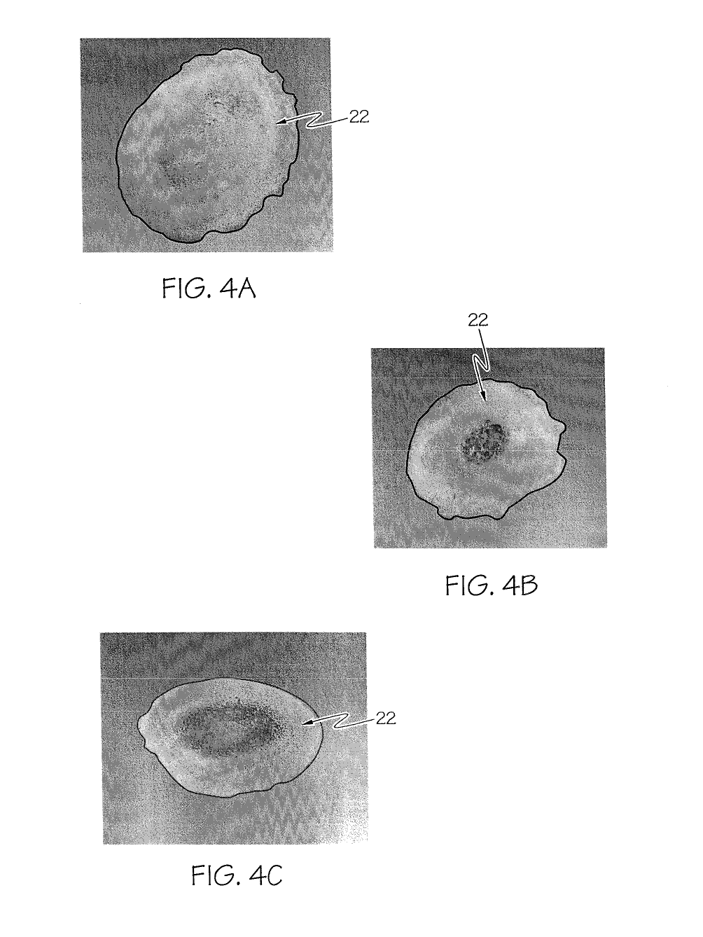

At least one bony process 20 is also provided. Examples of the types of bony process 20 that can be used to construct the mosaic 10 in the present invention include antlers, horns, and combinations thereof. In one embodiment, the bony process 20 used to construct the mosaic 10 is a deer antler, as shown in FIG. 3. Based on numerous factors, deer antler characteristics such as color, porosity, texture, shape, size, and moisture content vary from antler to antler. The variations in characteristics such as color, porosity, texture, shape, and size are illustrated by the differences in the cross-sectional pieces 22 shown in FIGS. 4A, 4B, and 4C.

The characteristics of an antler vary throughout its life cycle. Deer antlers are deciduous, meaning that they are shed at a certain stage of development in their life cycle. Deer generally shed their antlers each spring and immediately begin to grow new ones. During the early stages of an antler's life cycle it is covered with a sensitive skin referred to as “velvet.” The velvet is filled with blood vessels and, thus, the moisture content of the antler is higher when it is covered with velvet in its early stages. Normally, after two to four months, the velvet withers, dries up, and falls off. At this point the moisture content of the antler is lower.

The cross-sectional pieces 22 used in constructing the mosaic 10 can be taken from an deer. If desired, the cross-sectional pieces 22 can be freeze-dried to reduce their moisture content.

Once the bony process 20 is provided, it is cut into cross-sectional pieces 22. The bony process 20 may be cut into cross-sectional pieces 22 using a saw, such as a jigsaw or a band saw. The thicknesses of the cross-sectional pieces 22 may vary. In one embodiment of the present invention, the cross-sectional pieces 22 are generally circular and may be from about ⅛ to 1 inch thick, more preferably from ⅛ to ½ inches thick, and most preferably about a ¼ inch thick. In another embodiment, the cross-sectional pieces 22 have substantially identical thicknesses so that they create a substantially flat effect when they are affixed to the substratum 12. In yet another embodiment, the cross-sectional pieces 22 vary in thickness so that they create a three-dimensional effect when affixed to the substratum 12. It will be appreciated by one skilled in the art that the cross-sectional pieces 22 may also be one of many numerous shapes, including, but not limited to, polygonal, trapezoidal, rectangular, square, triangular, and oval.

Next, the cross-sectional pieces 22 may be either polished or left rough. In polishing the cross-sectional pieces 22, the first sides 24 are sanded. The first sides 24 can initially be sanded with sandpaper having an abrasiveness of around 320 grit. Then, the first sides 24 can be sanded with progressively finer sandpapers and can be finished with sandpaper having an abrasiveness of around 1000 grit or crocus cloth. Polishing removes the dust that is deposited in the pores of the first sides 24 during the cutting process. The cross-sectional pieces 22 can then be artificially colored, artificially stained, and/or left in their natural state.

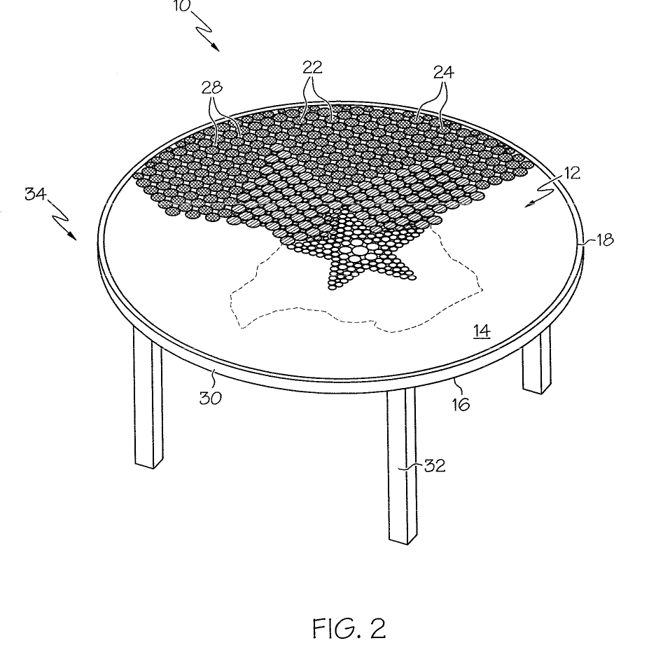

The cross-sectional pieces 22 are then arranged on the substratum 12. The cross-sectional pieces 22 are arranged such that their second sides 26 are removably placed on the manner to form a design. As shown in FIGS. 1 and 2, a design can be formed by strategically arranging cross-sectional pieces 22 with different characteristics such as color, thickness, and size. For example, in one embodiment, as illustrated in FIGS. 1 and 2, the state of Texas with a star in the middle can be formed. Other designs can be formed, including, but not limited to, the logos of sports teams, universities, and corporations.

Once the cross-sectional pieces 22 have been arranged on the substratum 12, they may then be affixed to the substratum 12. The cross-sectional piece second sides 26 are affixed to the substratum first side 14. In one embodiment, the cross-sectional pieces 22 are affixed to the substratum first side 14 with an adhesive, although it will be appreciated by one skilled in the art that any suitable material may be used to affix the cross-sectional pieces 22 including, but not limited to, adhesive, glue, tape, hooks and loops, tacks, and nails.

Next, the voids 28 in between the cross-sectional pieces 22 may be filled with a material. The material used to fill the voids 28 may be selected from a group consisting of polyurethane, resin-based material, acrylic, earth, sand, and combinations thereof.

Then, the cross-sectional pieces 22 and the material in the voids 28 can be coated with a protective material. In one embodiment, the protective material is a clear polyurethane, although it will be appreciated by one skilled in the art that any suitable protective material may be used to coat the cross-sectional pieces 22 and the material in the voids 28, including, but not limited to, resin varnish, spar varnish, shellac, acrylic, and lacquer.

Next, a border 30 can be affixed to the at least one substratum sidewall 18. The border 30 can serve as a periphery if the mosaic 10 is used as a table top 34 as shown in FIG. 2. The wall.

Finally, at least three legs 32 may be affixed to the substratum second side 16 to form a table 34 as shown in FIG. 2. In another embodiment, a means for hanging (not shown) may be affixed to the mosaic 10 so that it can be suspended for display.

From the foregoing, it may be seen that the mosaic and the method for producing it is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

1. A method for producing a mosaic comprising the steps of:
providing a generally planar substratum having a first side, a second side, and at least one sidewall;
providing a bony process selected from a group consisting of horns, antlers, and combinations thereof;
cutting said bony process into a plurality of cross-sectional pieces, each of said pieces having a first side and a second side;
arranging said cross-sectional pieces on said substratum first side; and
affixing said second sides of cross-sectional pieces to said substratum first side.

2. The method of claim 1 wherein said substratum has a coefficient of thermal expansion substantially similar to the coefficient of thermal expansion of said bony process.

3. The method of claim 1 wherein said bony process is selected from a group consisting of horns, antlers, and combinations thereof.

4. The method of claim 1 wherein said bony process is freeze dried.

5. The method of claim 1 wherein each of said cross-sectional pieces have a thickness of from about 1/8 to 1 inch.

6. The method of claim 1 wherein said cross-sectional pieces have substantially similar thicknesses and are affixed to said substratum first side to create a substantially flat effect.

7. The method of claim 1 wherein said cross-sectional pieces have varying thicknesses and are affixed to said substratum first side to create a three-dimensional effect.

8. The method of claim 1 further comprising the step of polishing said first sides of said cross-sectional pieces.

9. The method of claim 1 further comprising the step of artificially coloring said first sides of said cross-sectional pieces.

10. The method of claim 1 further comprising the step of arranging said cross-sectional pieces in a manner to form a design.

11. The method of claim 10 further comprising the step of affixing said second sides of said cross-sectional pieces to said substratum first side with an adhesive.

12. The method of claim 11 wherein said cross-sectional pieces define voids therebetween.

13. The method of claim 12 further comprising the step of filling said voids with a material.

14. The method of claim 13 wherein said material is selected from a group consisting of polyurethane, resin-based material, acrylic, earth, sand, and combinations thereof.

15. The method of claim 1 further comprising the step of coating said cross-sectional pieces with a protective material.

16. The method of claim 1 further comprising the step of affixing a border around said at least one sidewall.

17. The method of claim 1 further comprising the step of affixing at least three legs to said substratum second side to form a table.

18. The method of claim 1 further comprising the step of affixing a means for hanging said mosaic.

19. A method for producing a mosaic comprising the steps of:
providing a generally planar substratum having a first side and a second side;
providing a deer antler;
cutting said deer antler into a plurality of cross-sectional pieces each of said cross-sectional pieces having a first side and a second side;
polishing said first side of said cross-sectional pieces with an abrasive material;
arranging said cross-sectional pieces on said substratum first side;
affixing said second side of said cross-sectional pieces to said substratum first side with an adhesive; and
filling voids created by said arranging of said cross-sectional pieces with a material wherein said material is selected from a group consisting of polyurethane, resin-based material, acrylic, earth, sand, and combinations thereof.

20. A mosaic comprising:
a generally planar substratum having a first side and a second side; and
at least one bony process cut into a plurality of cross-sectional pieces each of said cross-sectional pieces having a first side and a second side;
wherein said first side of said cross-sectional pieces is polished using an abrasive material;
wherein said cross-sectional pieces are arranged on said substratum first side;
wherein said second side of said cross-sectional pieces is affixed to said substratum first side with an adhesive; and
wherein voids created by said arranging of said cross-sectional pieces are filled with a material.
